(19) United States
(12) Patent Application Publication
(10) Pub. No.: US 2025/0240749 A1
(43) Pub. Date: Jul. 24, 2025

(54) Managing Uplink Time Alignment

(71) Applicant: GOOGLE LLC, Mountain View, CA (US)

(72) Inventor: Shiangrung Ye

(21) Appl. No.: 18/703,338

(22) PCT Filed: Oct. 21, 2022
(86) PCT No.: PCT/US2022/078565

§ 371 Date: Apr. 20, 2024

Related U.S. Application Data
(60) Provisional application No. 63/262,883, filed on Oct. 21, 2021.

(51) Int. Cl. H04W 56/00; H04W 72/1268; H04W 76/30

(52) U.S. Cl. CPC H04W 56/0045; H04W 72/1268; H04W 76/30

(57) ABSTRACT

To maintain uplink time alignment, a UE initiates a small data transmission (SDT) procedure; the starts a first timer in response to the initiating; the UE receives, while the first timer is running, a time alignment command (TAC); and in response to receiving the TAC, the UE starts or restarts a second timer that controls a use of a configured grant for transmitting small data.

### FIELD OF THE DISCLOSURE

This disclosure relates to wireless communications and, more particularly, to managing uplink alignment for small data (or “early data”) communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE is in the RRC_IDLE or RRC_INACTIVE state can perform an early data transmission (EDT), also known as small data transmission (SDT), without transitioning to the RRC_CONNECTED state.

In some systems or scenarios, a UE performs a contention-based random access procedure to transmit small data in RRC_INACTIVE. In other systems or scenarios, a UE stores a resource for uplink transmissions, such as a configured grant, and not perform a random access procedure to transmit small data. It is not clear how the UE should manage time alignment when transmitting uplink data using a configured resource. In particular, the UE can use one timer for delimiting the period of time during which the UE remains synchronized with the base station in the uplink (UE to base station) direction, and another timer for delimiting the period of time during which the UE can use the configured radio resource for transmitting small data. When a base station uses a cell network temporary identifier (C-RNTI) (rather than a preconfigured uplink resources RNTI (PUR-RNTI), for example) to transmit a time alignment command to a UE, the MAC layer of the UE cannot determine which of these timers the UE should start or restart.

### SUMMARY

After a UE operating in the RRC_INACTIVE or RRC_IDLE state transmits small data using a configured grant, the UE starts a timer to delimit a period of time during which a subsequent transmission can occur or a response from the network can arrive, for example. When the UE receives a time alignment command (TAC) during this period, the UE starts or restarts a timing alignment timer (TAT) for SDT, referred to in this disclosure as SDT-TAT. The UE can receive the value for the SDT-TAT timer in an RRC Release command, for example. However, when the UE operating in the RRC_ACTIVE state receives the TAC command, the UE starts or starts a different timer, TAT, which delimits a period of time during which the UE and a base station remain synchronized in an uplink (UE to base station) direction.

In other implementations, the UE starts the SDT-TAT timer in response to receiving a certain media medium access control (MAC) control element (CE), and starts the TAT timer in response to receiving a different MAC CE. In still other implementations, the UE determines whether it should start a TAT timer or an SDT-TAT timer depending on the search space to which a downlink control indicator (DCI) scheduling a MAC protocol data unit (PDU) refers. In yet other implementations, the UE determines whether it should start a TAT timer or an SDT-TAT timer depending on whether the TAC arrives during an SDT random access procedure or a non-SDT random access procedure.

An example embodiment of these techniques is a method in a UE for maintaining uplink time alignment. The method includes initiating, by the UE, a small data transmission (SDT) procedure; starting a first timer in response to the initiating; receiving, while the first timer is running, a time alignment command (TAC); and in response to receiving the TAC, starting or restarting a second timer that controls a use of a configured grant for transmitting small data.

Another example embodiment of these techniques is a UE with processing hardware and a transceiver. The UE is configured to implement the method above.

### BRIEF DESCRIPTION OF THE DRAWINGS

FIG. 1 is a block diagram of an example wireless communication system in which a UE and a radio access network (RAN) can implement the techniques of this disclosure for managing timing alignment in SDT scenarios;

FIG. 2 is a block diagram of an example protocol stack according to which the UE of FIG. 1 can communicate with base stations of FIG. 1;

FIG. 3 is a messaging diagram of an example scenario in which the RAN and a UE of FIG. 1 manage time alignment;

FIG. 4A is a flow diagram of an example method for determining whether the UE should user the SDT-TAT or the TAT based on the type of the MAC CE that included the TAC;

FIG. 4B is a flow diagram of an example method for determining whether the UE should user the SDT-TAT or the TAT based on the search space in which the UE received the DCI scheduling the MAC PDU with the TAC;

FIG. 4C is a flow diagram of an example method for determining whether the UE should user the SDT-TAT or the TAT based on the type of the random access procedure during which the UE received the TAC;

FIG. 4D is a flow diagram of an example method for determining whether the UE should user the SDT-TAT or the TAT based on whether a certain timer was running when the UE received the TAC; and

FIG. 5 is a flow diagram of an example method for managing timing alignment, which can be implemented in the UE of FIG. 1.

### DETAILED DESCRIPTION OF THE DRAWINGS

Generally speaking, a UE can use preconfigured uplink resources (PUR) to transmit small data to the RAN when operating in RRC_IDLE or RRC_INACTIVE. The UE manages timing alignment with the RAN using one or more timers.

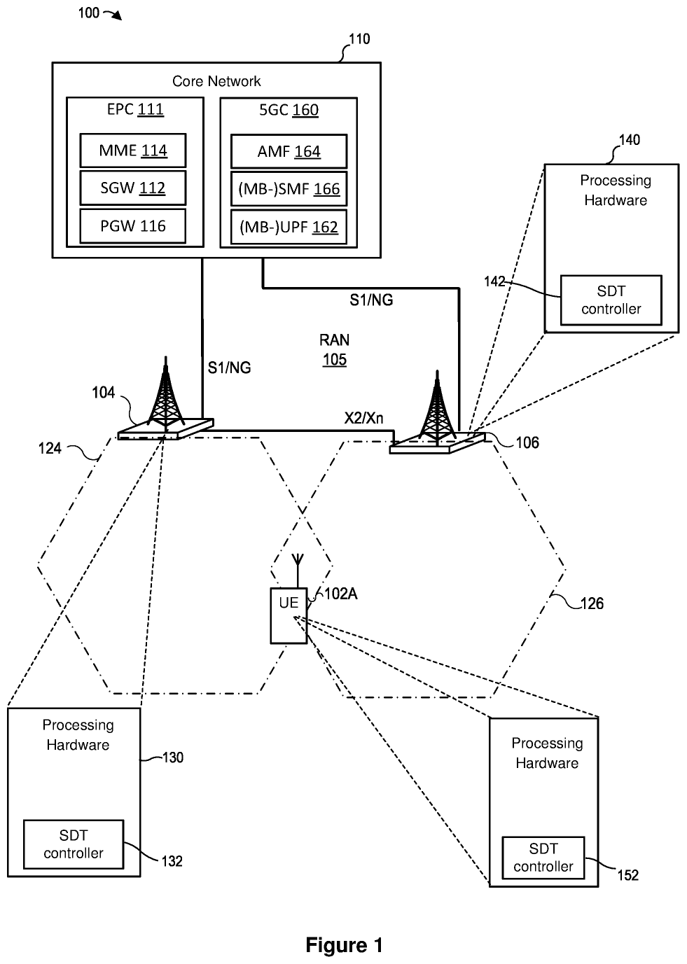

Referring first to FIG. 1, an example wireless communication system 100 includes user equipment (UEs) 102, as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102 can be in range to communicate with base station 104 while simultaneously being in range to communicate with the base station 106 (or in range to detect or measure signals from the base station 106). The overlap can make it possible for the UE 102 to hand over between the cells (e.g., from the cell 124 to the cell 126) or base stations (e.g., from the base station 104 to the base station 106) before the UE 102 experiences radio link failure, for example. Moreover, the overlap allows the various dual connectivity (DC) scenarios. For example, the UE 102 can communicate in DC with the base station 104 (operating as a master node (MN)) and the base station 106 (operating as a secondary node (SN)). When the UE 102 is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1 includes an SDT controller 132 that is configured to manage SDT transmission and PUR. The base station 104 also includes one or more transceivers to communicate with UEs over a radio interface, and an interface for communicating with other base stations and the CN 110 (neither shown to avoid clutter). Similarly, the base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. A includes an SDT controller 142, which may be similar to the controller 132. Although not shown in FIG. 1, the RAN 105 can include additional base stations with processing hardware similar to the processing hardware 130 of the base station 104 and/or the processing hardware 140 of the base station 106.

The UE 102 includes processing hardware 150, which can include one or more general-purpose processors (e.g., CPUs) and a computer-readable memory storing machine-readable instructions executable on the general-purpose processor(s), and/or special-purpose processing units. The UE 102 also includes one or more transceivers to communicate with the RAN 105 over the radio interface. The processing hardware 150 in the example implementation of FIG. 1 includes an SDT controller 152 that is configured to manage SDT, PUR, and timing alignment. For example, the UE SDT controller 152 can be configured to support SDT, PUR management, and timing alignment as discussed below.

The CN 110 may be an evolved packet core (EPC) 111 or a fifth-generation core (5GC) 160, both of which are depicted in FIG. 1. The base station 104 may be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102) to one or more external packet data networks, e.g., an Internet network and/or an Internet Protocol (IP) Multimedia Subsystem (IMS) network. The 5GC 160 can include a user plane function (UPF) 162 and an access and mobility management function (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

More generally, the wireless communication system 100 may include any suitable number of base stations supporting NR cells and/or EUTRA cells. The EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102 can communicate with the base station 104 and the base station 106 via the same radio access technology (RAT), such as EUTRA or NR, or via different RATs.

When the base station 104 is an MeNB and the base station 106 is an SgNB, the UE 102 can be in EN-DC with the MeNB 104 and the SgNB 106. When the base station 104 is an Mng-eNB and the base station 106 is an SgNB, the UE 102 can be in next generation (NG) EUTRA-NR DC (NGEN-DC) with the Mng-eNB 104 and the SgNB 106. When the base station 104 is an MgNB and the base station 106 is an SgNB, the UE 102 can be in NR-NR DC (NR-DC) with the MgNB 104 and the SgNB 106. When the base station 104 is an MgNB and the base station 106 is an Sng-eNB, the UE 102 can be in NR-EUTRA DC (NE-DC) with the MgNB 104 and the Sng-eNB 106.

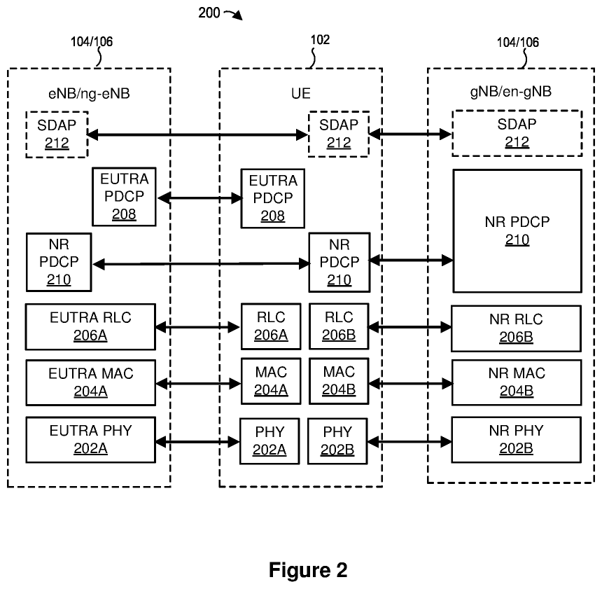

FIG. 2 illustrates, in a simplified manner, an example protocol stack 200 according to which a UE (e.g., UE 102) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPV6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102 operates in EN-DC with the base station 104 operating as an MeNB and the base station 106 operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102 uses the PHY sublayer 202, MAC sublayer 204, RLC sublayer 206, PDCP sublayer 208, and SDAP sublayer 212 to receive the MBS data packets.

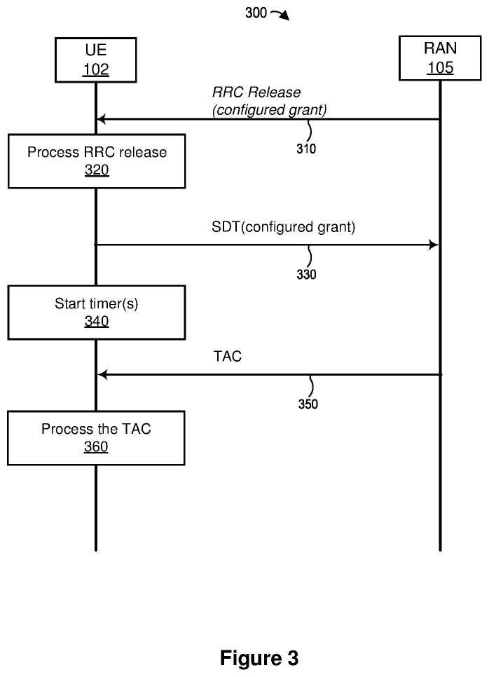

An example scenario 300 in which the UE 102 and the RAN 105 manage SDT and timing alignment is discussed below with reference to FIG. 3. The RAN 105 can be referred to below as “the network.” Data which the UE 102 transmits using SDT can satisfy the definition of “small data” based on volume and/or the logical channel configuration associated with the data, as described in 3GPP TS 38.32, for example.

Generally speaking, using LTE preconfigured uplink resources (PUR), an eNB transmits an RRC release message with a PUR configuration to a UE. The RRC release message causes the UE to transition to the RRC_INACTIVE state. The PUR configuration includes a PUR-RNTI and a configured radio resource. The UE can use the configured radio resource to transmit data while operating in RRC_INACTIVE. After the transmission, the UE can use the PUR-RNTI to monitor PDCCH for a response from the eNB. The PUR configuration can include a PUR timing alignment timer (PUR-TAT) used to control the use of the configured radio resource. If the PUR-TAT expires or is stopped, the UE is not allowed to use the configured radio resource. If the UE receives a time alignment command (TAC) in a MAC PDU on PDSCH that is addressed to PUR-RNTI, the UE restarts the PUR-TAT. The TAC indicates a time offset for UE to adjust its uplink timing. Further, in RRC_CONNECTED, the UE uses another timing alignment timer called TAT to determine whether uplink is synchronized between UE and gNB. If the UE receives a TAC in PDSCH that is addressed to C-RNTI, the UE restarts the TAT.

For NR SDT, similar to LTE PUR, a gNB transmits an RRC release message that includes a configured grant to a UE. Generally similar to PUR-TAT, a new timer, which can be referred to as SDT-TAT, controls the use of the configured grant. If the SDT-TAT expires or the UE stops the SDT-TAT, the UE cannot use the configured grant to transmit data. However, the gNB uses C-RNTI instead of using a PUR-RNTI for example. As a result, without the techniques discussed below, the MAC layer of the UE 102 cannot determine whether the UE 102 should activate the SDT-TAT or the TAT in response to receiving a TAC.

Initially, the RAN 105 transmits 310 an RRC release message to UE 102, which can operate in the RRC_CONNECTED state. The RRC release message can indicate whether the UE 102 should transition to the RRC_IDLE state or the RRC_INACTIVE state. The RRC release message in an example scenario includes a configured grant, or a time-frequency resource that UE 102 can use to transmit small data. The RRC release message also can indicate a modulation and coding scheme for transmission of small data. The RRC release message also can configure the duration of the SDT-TAT. On the other hand, the network 110 can indicate the duration of the TAT via an RRC Reconfiguration message (e.g., RRCReconfiguration).

The UE 102 then processes 320 the RRC release message. In some implementations, upon receiving the RRC release message, the UE 102 starts an SDT-TAT. The UE 102 in this scenario also enters the RRC_INACTIVE state.

The UE 102 can stop the SDT-TAT if the UE 102 initiates a non-SDT random access procedure or if the UE 102 changes the serving cell, for example. More particularly, when communicating over the NR radio interface, the UE 102 can initiate configured-grant-based SDT (CG-SDT) or random-access-based SDT (RA-SDT) to transmit small data. According to the CG-SDT approach, the UE 102 uses a configured grant to transmit small data; according to the RA-SDT approach, the UE initiates random access procedure to transmit small data. A non-SDT random access procedure on the other hand is a random access procedure that involves different resources (preambles, PRACH time/frequency resource, etc.) than the random access procedure of RA-SDT. The UE 102 may initiate a non-SDT random access procedure when the UE 102 has non-small data arriving in a buffer, or when the current signal strength/quality is below a threshold.

Regarding a change in the serving cell, the UE 102 can perform cell selection or reselection. In another scenario, the UE 102 transmit an RRC resume request message or an RRC connection establishment message in a serving cell different from one in which the UE 102 operated prior to transmitting the RRC message.

Next, the UE 102 uses the configured grant to transmit 330 small data to the RAN 105. In other scenarios, the UE 102 initiates an SDT random access procedure to transmit small data.

After the UE 102 transmits the small data using the configured grant, or after the UE 102 competes the SDT random access procedure, the UE 102 starts 340 a timer that delimits a period of time during which the UE 102 waits for a response. This timer can be referred to in this discussion as the “first timer.” The UE 102 in some implementations obtains the value of the first timer in the RRC release message (event 310 discussed above).

Activation of the first timer also can be understood as the beginning of a subsequent transmission period. In particular, after the UE 102 transmits small data with a configured grant (i.e. preconfigured radio resource) or dynamic grant (i.e. dynamically assigned radio resource), a subsequent transmission period begins. During that subsequent transmission period, the UE 102 can monitor the Physical Downlink Control Channel (PDCCH) to receive downlink data or uplink grants. After the subsequent transmission period ends, the UE 102 can stop monitoring the PDCCH for downlink data or an uplink grant.

In other example scenario, the subsequent transmission period begins after the UE 102 completes the random access procedure of RA-SDT (as indicated above, the RA-SDT procedure involves different RACH resources such as preambles and PRACH time-frequency resources relative to a non-SDT random access procedure).

In yet another example scenario, the first timer delimits the period of time during which the UE 102 waits for a response from the network to transmitting 330 the previous uplink transmission. The response can include HARQ feedback or an uplink grant for retransmission, for example. If the UE 102 does not receive a response from the network before the first timer expires, the UE 102 retransmits the small data, in one implementation.

Further, the UE 102 can stop the first timer if one or more of the following conditions is satisfied: (i) the UE 102 initiates a non-SDT random access procedure, (ii) the UE 102 changes the serving cell after cell selection or reselection, (iii) the SDT-TAT expires, or (iv) the UE 102 stops the SDT-TAT.

In some implementations, the UE 102 starts or restarts the first timer after each transmission scheduled according to the configured grant or dynamic grant. However, when the transmission is scheduled according to dynamic scheduling of a temporary C-RNTI (e.g., the transmission occurs in msg3 of a random access procedure), the UE 102 does not restart the first timer because the temporary C-RNTI is not a UE-specific RNTI. In this case, the base station is now aware of which UE restarts the first timer, and thus the timer status is not synchronized between the UE and the base station. The base station in this scenario can be a gNB.

When the radio interface between UE 102 and the RAN 105 is NR, and when the UE 102 transmits a random access preamble, or msg1 of the random access procedure, the RAN 105 in response transmits a RAR, or msg2 of the random access procedure, to the UE 102. After receiving the RAR, the UE 102 transmits msg3 to the base station. If the base station does not receives msg3, the base station can schedule a retransmission by sending an uplink grant to the UE 102. The base station can include the uplink grant in a DCI addressing a temporary C-RNTI, and the base station transmits the DCI on the PDCCH of the physical channel.

With continued reference to FIG. 3, the RAN 105 next transmits 350 a TAC to the UE 102. In some implementations, the RAN 105 transmits the TAC to the UE 102 in a MAC CE. In some implementations of the RAN 105, e.g., Release 16 NR, the TAC MAC CE is associated with a logical channel ID. To detect the TAC MAC CE, the UE 102 checks the subheaders of the MAC PDU. If the UE 102 determines that a certain filed in the subheader contains the logical channel ID, the UE 102 can determine that the TAC MAC is present in the MAC PDU, and the UE 102 further can determine where in the MAC PDU the value of the TAC MAC CE begins. The RAN 105 alternatively can transmit the TAC in msg2, msg4 of a four-step random access procedure, or in msgB of a two-step random access procedure.

Next, the UE 102 processes 360 the TAC. In some implementations, the RAN 102 and the UE 102 define a MAC CE specifically for SDT-DAT. Thus, when the UE 102 receives the MAC CE defined specifically for SDT-DAT, the UE 102 starts or restarts the SDT-TAT. However, when the UE 102 receives the TAC MAC CE as defined in Release 16 implementation, for example, the UE 102 starts or restarts the TAT rather than the SDT-DAT. The MAC CE defined specifically for SDT-TAT can be associated with a logical channel ID different from the logical channel ID associated with TAC MAC CE. The UE 102 can use the logical channel to identify a MAC CE.

According one a certain implementation, when the UE 102 receives 350 a TAC in the MAC PDU, and the UE 102 receives a DCI scheduling the MAC PDU in a certain (first) search space or code set, the UE 102 starts or restarts the SDT-TAT. However, if the UE 102 receives a TA a TAC in the MAC PDU, and the UE 102 receives a DCI scheduling the MAC PDU in another (second) search space or code set, the UE 102 starts or restarts the TAT. The RAN 105 can indicate 310 the first search space/code set in the RRC release message. A search space and code set generally speaking specifies the time/frequency radio resource the base station can use to transmit a DCI, which in turn includes a downlink radio resource the base station can use to transmit downlink data to a UE. The DCI also can include an uplink radio resource which a UE can use to transmit small data.

Thus, in this implementation, the base station uses the partitioning of radio resources for DCI transmission to distinguish a TAC activating an SDT-TAT from a TAC activating a TAT.

In another implementation, when the UE 102 receives the TAC in msg2 or msg4 of an SDT random access procedure, the UE 102 starts or restarts the SDT-TAT. However, if the UE 102 receives the TAC in msg2 or msg4 of a non-SDT random access procedure, the UE 102 starts or restarts the TAT. More specifically, in a two-step random access procedure, the UE 102 transmits msgA to the base station, and the base station transmits msgB to the UE 102 in response. If the UE 102 receives a TAC in msgB during the SDT random access procedure, the UE 102 starts or restarts the SDT-TAT. If the UE 102 receives a TAC in msgB during a non-SDT random access procedure, the UE 102 starts or restarts the TAT.

In another implementation, when the UE 102 receives the TAC while the first timer is running, UE start or restarts the SDT-TAT. In other words, if the UE 102 receives the TAC in a subsequent transmission period (discussed above), the UE starts or restarts the SDT-TAT.

In another implementation, if the UE 102 receives the TAC during a paging occasion, UE starts or restarts the SDT-TAT. In yet another implementation, if the UE 102 is the RRC_INACTIVE or RRC_IDLE state when the TAC arrives, the UE 102 starts the SDT-TAT. However, if the UE 102 is in RRC_CONNECTED state when the TAC arrives, the UE 102 starts the TAT.

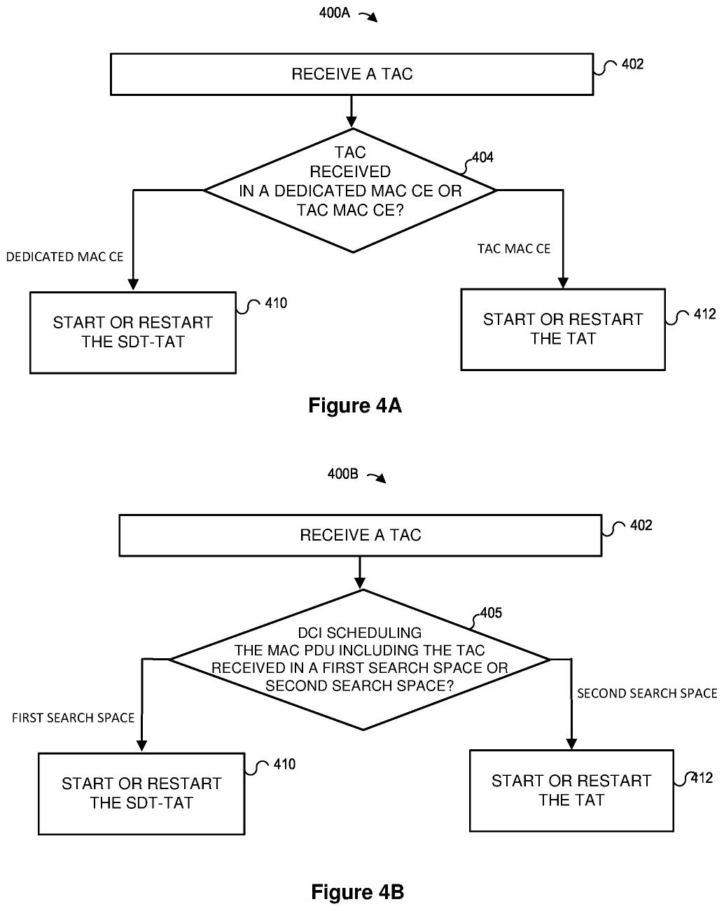

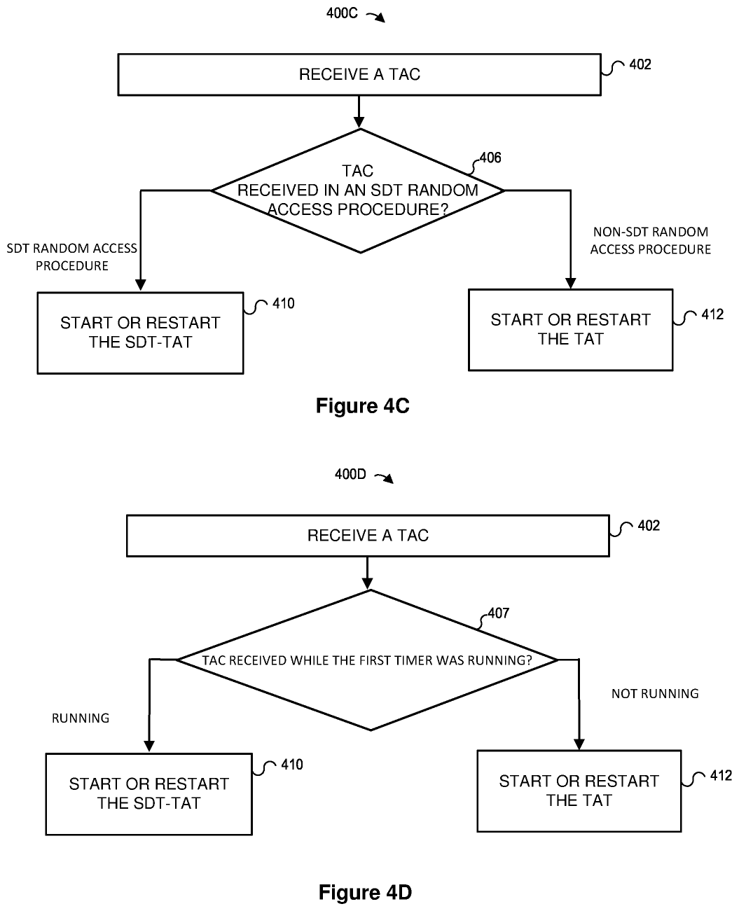

Now referring to FIG. 4A, a UE such as the UE 102 of FIG. 1 can implement the method 400A as a set of instructions stored on a computer-readable medium and executable by processing hardware such as one or more processors. The method 400 begins at block 402, where the UE receives a TAC (see also event 350). At block 404, the UE determines whether the TAC arrived in a dedicated MAC CE or a TAC MAC CE, so as to process the TAC accordingly (see also event 360). If the TAC is associated with a dedicated MAC CE, the flow proceeds to block 410, where the UE starts or restarts the SDT-TAT. Otherwise, the flow proceeds to block 412, where the UE starts the TAT.

The method 400B of FIG. 4B is generally similar to the method 400A, except that here the UE determines whether the UE receives the DCI scheduling the MAC PDU, in which the TAC arrived at the UE, in a first search space/code set or the second search space/code set. If the DCI is associated with the first search space, the flow proceeds to block 410; otherwise, the flow proceeds to block 412.

The method 400C of FIG. 4C is generally similar to the method 400A, except that here the UE determines whether the UE received the TAC in an SDT random access procedure or a non-SDT random access procedure. If the UE received the TAC in an SDT random access procedure, the flow proceeds to block 410; otherwise, the flow proceeds to block 412.

The method 400D of FIG. 4D is generally similar to the method 400A, except that here the UE determines whether the UE received the TAC while the first timer (delimiting a period of time during which the UE waits for a response from the network) is running. If the UE received the TAC while this timer was running, the flow proceeds to block 410; otherwise, the flow proceeds to block 412.

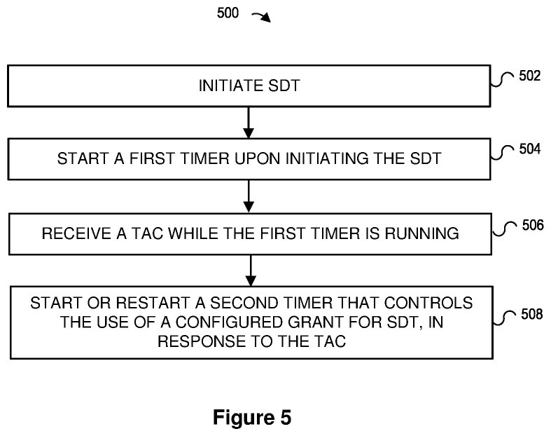

FIG. 5 illustrates an example method 500 which the UE 102 or a similar UE can implement to manage uplink time alignment with a RAN. At block 502, the UE initiates SDT (see event 310). At block 504, the UE starts a first timer upon transmitting small data or completing the random access procedure (see event 340). The timer can delimit a period of time during which the UE waits for a response from the network. At block 506, the UE receives a TAC while the timer is running (see event 350; block 402). At block 508, in response to determining that the TAC arrived while the first timer was running (block 407), the UE starts a second timer (e.g., SDT-TAT) delimiting the use of a configured grant for SDT (see block 410).

Referring generally to the diagrams above, the UE and/or the RAN implement some or all of the following additional techniques.

In some NR systems, a gNB can configure a UE with skipUplinkTxDynamic. With skipUplinkTxDynamic configured, when the UE has a configured grant but there is no data and CSI to transmit, UE can omit the uplink transmission. For CG-SDT, the UE can similarly omit uplink transmission. In particular, the UE may not have frequent data arrivals in RRC_INACTIVE. If omitting uplink transmission is not supported, the UE may need to transmit a BSR every time when the UE obtain a configured grant, which may result in excessive battery use.

Further, in some systems, the a UE can use a C-RNTI previously configured in the RRC_CONNECTED state to monitor PDCCH in CG-SDT. When the UE receives a Timing Advance Command (TAC), the UE should update SDT-TAT. Similarly, in RA-SDT, when a UE receives a TA command, the UE can update SDT-TAT. Because the MAC layer has SDT-TAT and TAT, when MAC receives a TA command it may be needed to determine to update SDT-TAT or/and TAT. One possible solution is to update the SDT-TA when the UE receives a TA command and the SDT failure timer is running.

Because the UE starts a time window after CG transmission for CG-SDT, when the UE receives a TA command within the window, the UE can update SDT-TAT with the TA.

For RA-SDT, the UE can check the search space in which the UE receives DCI scheduling PUSCH of the TA command. If the base station transmits the TA command in the PDSCH scheduled by the DCI on the search space configured for CG-SDT, the UE can update SDT-TAT.

Further, in some systems, switching from CG-SDT to RA-SDT in the initial CG transmission phase is not supported because of MAC PDU rebuilding. Further, in a subsequent transmission phase initiated by CG-SDT, when there is a configured grant for the UE to initiate a new CG transmission, but the conditions are not satisfied, it is unclear whether the UE can initiate RA-SDT. Accordingly, a UE in some embodiments considered herein can initiate RA-SDT. In other words, the UE can stop the CG-SDT Timer and then perform the RA-SDT procedure. The UE can restart the SDT failure timer (i.e. a T319-like RRC timer). Specifically, when the UE initiates any random access procedure (i.e. RA-SDT or legacy RA) during initial CG transmission phase or the subsequent transmission phase, the UE can stop the SDT failure timer.

Still further, during the subsequent transmission phase started by RA-SDT, when there is a configured grant for UE to initiate a new transmission, and the conditions to use configured grant are satisfied, it is unclear whether the UE can switch to CG-SDT, in at least some of the existing systems. A UE in one embodiment considered herein initiates the CG-SDT procedure. The UE can restart an SDT failure timer (i.e. a T319-like RRC timer).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in a user equipment (UE) for maintaining uplink time alignment, the method comprising:
initiating, by the UE, a small data transmission (SDT) procedure during which the UE communicates small data with a radio access network (RAN);
starting a first timer in response to the initiating;
receiving, while the first timer is running, a time alignment command (TAC); and
in response to receiving the TAC, starting or restarting a second timer that controls a use of a configured grant for transmitting small data.

2. The method of claim 1, wherein receiving the TAC includes receiving a medium access control (MAC) control element (CE).

3. The method of claim 1, wherein the first timer delimits a period of time during which the UE waits for a response to the initiating, from the network.

4. The method of claim 3, further comprising, prior to performing the SDT procedure:
receiving a command to release an RRC connection, the command including a value for the first timer.

5. The method of claim 1, further comprising, prior to performing the SDT procedure:
receiving a command to release an RRC connection, the command including the configured grant.

6. The method of claim 5, wherein the command includes a value of the second timer.

7. The method of claim 1, wherein:
the TAC is a first TAC, and
the method further comprising, in a second instance:
receiving, by the UE operating in an RRC connected state, a second TAC; and
in response to the second TAC, starting a third timer that delimits a period during which the UE and a base station are synchronized in an uplink direction.

8. The method of claim 7, further comprising:
receiving a command to reconfigure an RRC connection, the command including a value of the third timer.

9. The method of claim 1, wherein the TAC includes an indication of a time offset for adjusting uplink timing at the UE.

10. The method of claim 1, wherein performing the SDT procedure includes operating in an RRC inactive state or RRC idle state.

11. The method of claim 1, wherein initiating the SDT procedure includes:
transmitting, using the configured grant to a network, small data.

12. The method of claim 1 implemented in a MAC layer.

13. The method of claim 1, further comprising:
not using the configured grant after the second timer expires.

14. The method of any of claim 1, further comprising:
stopping the second timer in response to initiating a random access procedure for a non-SDT procedure.

15. A user equipment (UE) comprising processing hardware and configured to:
initiate a small data transmission (SDT) procedure during which the UE communicates small data with a radio access network (RAN);
start a first timer in response to the initiating;
receive, while the first timer is running, a time alignment command (TAC); and
in response to receiving the TAC, start or restart a second timer that controls a use of a configured grant for transmitting small data.

16. The UE of claim 15, further configured to, prior to performing the SDT procedure:
receive a command to release an RRC connection, the command including the configured grant.

17. The UE of claim 15,
the TAC is a first TAC, and
the UE is further configured to, in a second instance:
receive, by the operating in an RRC connected state, a second TAC, and
in response to the second TAC, start a third timer that delimits a period during which the UE and a base station are synchronized in an uplink direction.

18. The UE of claim 15, wherein the TAC includes an indication of a time offset for adjusting uplink timing at the UE.

19. The UE of claim 15, further configured to:
not use the configured grant after the second timer expires.

20. The UE of claim 15, further configured to:
stop the second timer in response to initiating a random access procedure for a non-SDT procedure.
